(19) United States
(12) Patent Application Publication
(10) Pub. No.: US 2019/0238900 A1
(43) Pub. Date: Aug. 1, 2019

(54) APPARATUS FOR PARTITIONING, ANALYZING, REPRESENTING, AND INTERACTING WITH INFORMATION ABOUT AN ENTITY

(71) Applicant: BRAINBABY INC, Santa Monica, CA (US)

(72) Inventor: Michael Montgomery, Santa Monica, CA (US)

(73) Assignee: BRAINBABY INC.

(21) Appl. No.: 16/257,407

(22) Filed: Jan. 25, 2019

Related U.S. Application Data
(60) Provisional application No. 62/622,793, filed on Jan. 26, 2018.

(51) Int. Cl. H04N 21/235; H04N 21/231; H04N 21/234; H04N 21/239; G06F 16/78; G06F 16/735; G06F 16/738

(52) U.S. Cl. CPC H04N 21/2353; H04N 21/23109; H04N 21/23418; G06F 16/738; G06F 16/7867; G06F 16/735; H04N 21/2393

(57) ABSTRACT

The present design is directed to a system for enhancing user selection of information. The system includes an information providing element configured to provide information related to a first entity to a user, a partitioning element configured to partition the information into a set of partitioned items, means for the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied in the graphical format representation. The system thus includes a video tagging/playback tool useful in creating an enhanced entertainment experience.

The present application claims priority based on U.S. Provisional Patent Application Ser. No. 62/622,793, filed Jan. 26, 2018, inventor Michael Montgomery, entitled “Apparatus for Partitioning, Analyzing, Representing, and Interacting with Information About an Entity,” the entirety of which is incorporated herein by reference.

### BACKGROUND OF THE INVENTION

### Field of the Invention

The present invention relates generally to the field of computing systems, and more specifically to computing systems used for identifying and selectively providing video under certain conditions to a user.

### Description of the Related Art

Certain computing devices provide live streaming and selection functionality relating to human activities such as dating, and certain functionality related to selection of candidates and tagging of videos. However, many of those types of platforms have offered limited functionality. Certain applications offer an ability to show a single representation and/or selected facts and limited text of an entity, such as a photograph or visual representation being displayed and the user electing whether he/she is interested in the person. This type of limitation constrains the ability for the user to identify people or products of interest, and does not give a full representation of the entity being considered. A deeper understanding and/or representation of the entity is desirable.

It would therefore be advantageous to provide a system that overcomes the issues and limitations of current devices employing entity review processing, such as reviewing persons for meeting or dating purposes, particularly when more details regarding the individual would be beneficial to the reviewer.

### SUMMARY OF THE INVENTION

According to one aspect of the present design, there is provided a system for enhancing user selection of information. The system includes an information providing element configured to provide information related to a first entity to a user, a partitioning element configured to partition the information into a set of partitioned items, means for the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied in the graphical format representation.

According to a further aspect, there is provided a system for enhancing user selection of information, comprising an information providing element configured to provide information related to a first entity to a user, a partitioning element configured to partition the information into a set of partitioned items, a tag applicator enabling the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied using the tag applicator in the graphical format representation.

According to another aspect, there is provided a system for enhancing user selection of information, comprising an information providing element configured to provide information related to a first entity to a user, a partitioning element configured to partition the information into a set of partitioned items, a tag applicator enabling the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied using the tag applicator in the graphical format representation. The interaction element is configured to determine an uptick score representing a difference in applied tags and/or markings at a low trough partition and applied tags and/or markings at a high peak partition.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a general overview of the apparatus;

FIG. 2 shows an event bar displayed on the device;

FIG. 3 is a series of event bars related to a first entity, showing interactions of the first entity with others;

FIG. 4 illustrates four stages or elements of the design;

FIG. 5 shows an example of a histogram employed in accordance with the present design, representing in one embodiment information provided by an information providing element including a histogram, video timeline, and a video;

FIG. 6 illustrates one aspect of the present design in a dating scenario;

FIG. 7 illustrates components of an individual interaction history;

FIG. 8 illustrates one representation presented to a user;

FIG. 9 is a representation of tags provided within divided partitions of a video;

FIG. 10 shows one aspect of the functional operation of the present design as it relates to the identification of partitions associated with upticks in tag volume;

FIG. 11 illustrates the system iteratively generating a series of lines from each trough point to every peak point with a higher partition value; and

FIG. 12 shows one embodiment of a system ranking for uptick scores.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual elements and functions are generally optional unless explicitly required, and the sequence of operations may vary. Portions and features of some embodiments may be included in, or substituted for, those of others.

Current devices provide certain levels of processing and as noted enable a user to view visual representations of persons, animals, products, and express an interest or disinterest in the entity. Common methods include marking a “yes” or “no” type indication, or “swiping” in a certain direction, or otherwise acting in a manner conveying or providing a level of interest or disinterest. Certain devices enable the user to indicate a level of ambivalence such as “maybe” or “check later.” However, in virtually all known instances, the user is presented with limited information about the entity being considered and thus is forced to form an opinion or preference based on less than optimal information.

The present design turns a selection experience, such as the dating experience, into an entertainment experience for others in the spirit of social media self-promotion and life-vlogging. This video tagging/playback tool contributes to that by enhancing the viewer experience.

The present design includes a general purpose computing device that includes hardware specially configured to allow for enhanced functionality in this realm. The design may be applicable to a dating situation, and much of the description provided herein relates to evaluating persons, but the design disclosed is not so limited. The design presented may be employed to evaluate animals, products, residences, and so forth and is not limited in this regard.

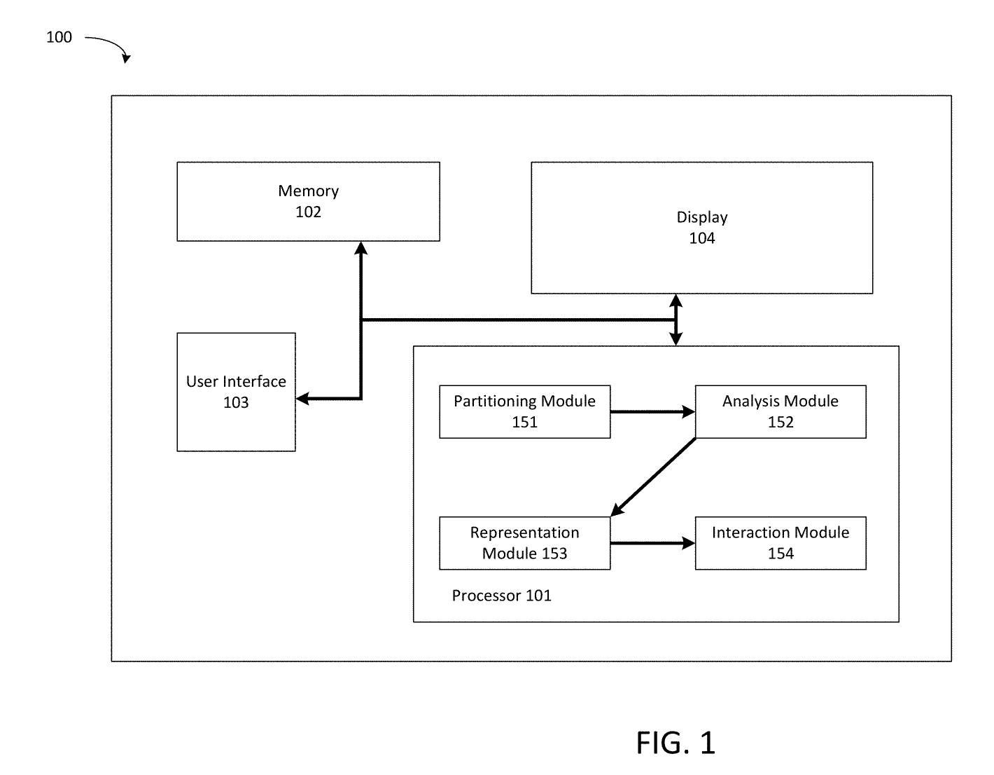

FIG. 1 illustrates a general overview of the apparatus. FIG. 1 illustrates device 100, processor 101, memory 102, user interface 103, and display 104. Also shown in FIG. 1 is a partitioning module 151, analysis module 152, representation module 153, and interaction module 154. These modules may be provided in hardware, software, or firmware in any combination; for example, a hardware partitioning module 151 and hardware interaction module 154 may be provided, with the other modules provided in software. These modules form part of processor 101 in the embodiment shown, but may be separate from processor 101.

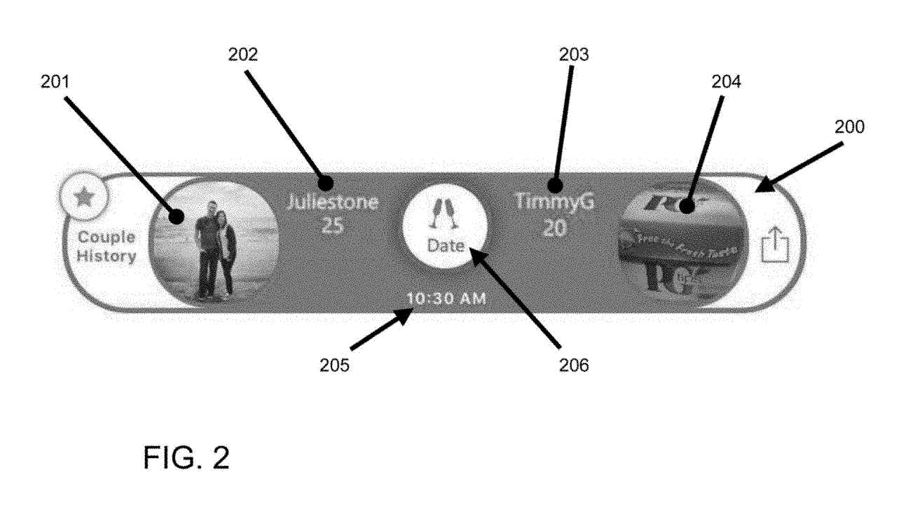

In sum, the present device records interactions between users and provides video or motion-based images for review, and in some instances audio and text chat, as well as commentary or evaluation indications or suggestions such that the reviewer can have more information about the entity and can better make a decision. Each of these decisions is represented graphically by an event bar. FIG. 2 shows an event bar 200 displayed on the device 100, including in this representation a visual representation 201 of a first entity, information 202 about the first entity, a visual representation 204 of a second entity and information 203 about the second entity, as well as information 205 and a central icon 206 representing some information relating to the first and second entities. In this representation, the first entity, Juliestone, had a morning engagement with the second entity, TimmyG. In this representation the ages of the individuals at the time of the interaction are provided.

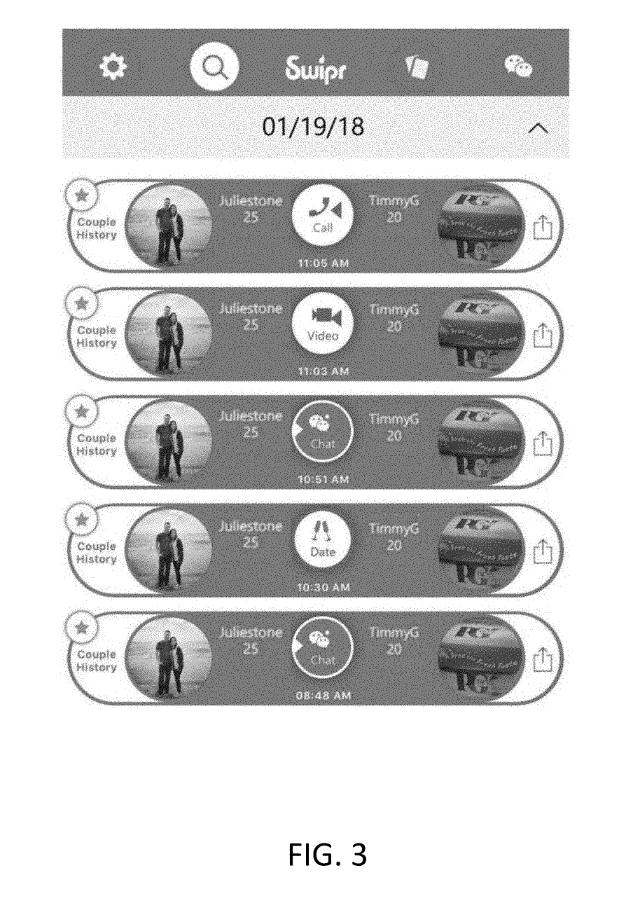

FIG. 3 illustrates a series of event bars related to the first entity, showing the various interactions first entity “Juliestone” has had with other entities. In some situations, a call occurred, in others a chat, and in others a video is provided. The representation provided in FIG. 3 is an event bar stack, representing a scrollable chronological configuration that can appear below a profile or other information. In operation, a user may browse the profile of any entity. While a single second entity, TimmyG, is shown in FIG. 3, it is to be understood that various interactions with multiple entities may be displayed or provided. Thus some first entities may have gone on dates or meetings with various second entities, and all those interactions and meetings may be displayed in the manner shown in FIG. 3. By selecting the central icon 206, the user may be directed to a representation of that interaction, whether a video, textual representation of an online chat, a call, or video of a date. The first entity may elect to hide these elements. One option is to collapse the elements into a header, but the user may personally elect to not have certain information provided. In one instance, a playback window may be provided to the user and an associated video, i.e. a video of the first entity's interaction with a second entity, may be displayed on the device.

During playback or display of information, such as video information, the viewing user may tag the video at any time with informational indications—emoticons or emojis, color indications, or any other indication expressing a thought or feeling regarding what is being viewed. In one instance, the user may be offered an ability to indicate emotions such as “like,” “dislike,” “laugh,” “cry,” “horror,” etc., identifying the moment or moments where the user has the cited thought(s) or reaction(s). Such information is recorded and may be provided to subsequent users viewing the information, such as a subsequent user viewing a video. New tags may be offered and older tags may be removed and in some instances some tags may be reclassified as appropriate. The design may also refuse to employ some tags, such as repeated attempts by one user to apply multiple tags to the same video.

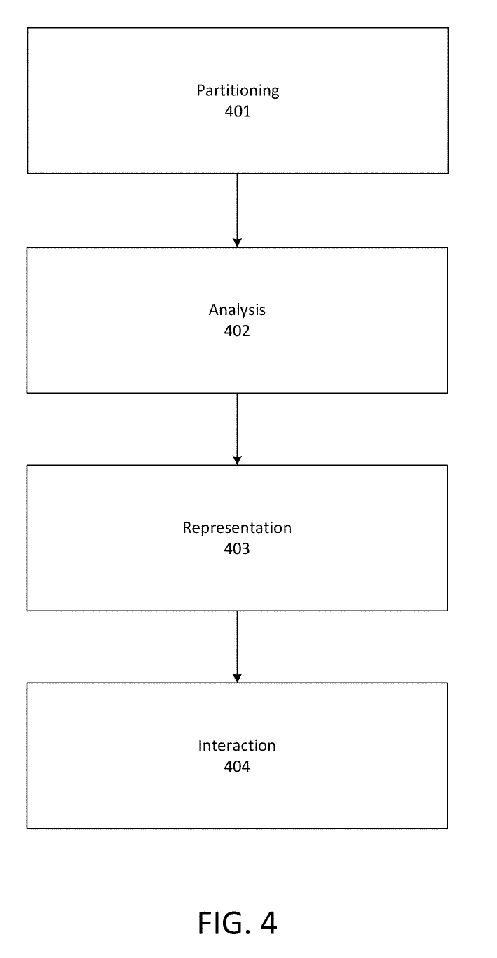

One aspect of the current design is a “scrubbing tool” that compartmentalizes video, processes the tags, and represents the tags in a novel visual manner such that a user can interact to select or de-select the most evocative moments in the video. FIG. 4 illustrates the four stages or elements of the design, including partitioning element 401, analysis element 402, representation element 403, and interaction element 404. Each of these elements may be implemented in hardware, software, or some combination thereof and are generally referred to as “elements” herein.

Information is initially provided to the system, and the system may optionally include an information providing element (not shown in FIG. 4) configured to provide information related to a first entity to a user, such as audio or video or other relevant information. Information may be provided by one or more elements, including but not limited to memory 102 and user interface 103.

With the information provided by an information providing element, partitioning element 401 generally, in the case of audio or video, establishes a duration “t” and compartmentalizes the audio or video into “n” partitions, wherein each partition comprises an equal or approximately equal number of audio or video frames. Of course, for example, in the case of a video of size S, the video may be partitioned into 17 partitions of 65536 video frames with one additional partition of 43210 frames. Other partitioning schemes may be employed, including but not limited to determining logical break points in the video, such as a period of silence or inactivity, and partitioning between the cuts to an equal or approximately equal partition length. While described herein primarily with respect to video, it is to be understood that the system also provides similar audio functionality.

In another partitioning arrangement, the number n, representing the number of partitions, is determined according to the following:
If t (duration of the video) is less than or equal to 1000 seconds, then n is the closest integer to t/10 but not less than 1
If t is greater than 1000 seconds, then n is the closest integer to t/60

The system then creates n partitions, each one corresponding sequentially to an equal, or as close to equal, number of frames in the video. A user may then view the video and attach informational indication (emoji, text, color, etc.) to the partition to which the tagged frame corresponds. Over time, as the video is viewed by other users, partitions may accumulate multiple tags corresponding to the emotional or other reactions of users. The result of partitioning element 401 is a set of partitions, wherein tags may be applied and collectively attached to the individual partitions.

Analysis 402 and representation 403 elements operate as follows. Once a user selects playback of a tagged video, such as one tagged by one or more users, or prior to such selection, the system analyzes the video for each type of tag recorded within each partition. The system may employ certain processing, for example, to remove redundant tags, such as multiple identical tags within a short time from the same entity, or improper tags. The system then generates a representation of the tags illuminated, such as in a bar graph or other visual representation, wherein the system determines appearance by a number and nature of tags available. In some instances no tags may be available, while in others, thousands may be available. Different representations are possible, but in one case, each partition is represented by a bar in a histogram. The width of the bar on the x-axis may correspond to the total width, i.e. the total length of the video, divided by n, the number of partitions. The vertical amplitude, i.e. the amplitude on the y axis, denotes the number of tags in that partition as a percentile of total tags in all partitions or in that partition. While a percentile is one way of performing this computation/determination, other methods may be employed. The y-axis representations may be displayed according to a logarithmic scale. Display according to a logarithmic scale may compensate for significant differences between tags in certain partitions. Such system functionality is a way of limiting the y-axis range broadly and improving the representation to user. So, if there are 1, 2, 3, and 3000 tags in four different partitions, the log scale employed by the system makes the low-tagged partitions relatively ‘bigger’ and therefore more visible relative to the partition that includes 3000 tags. A linear relationship or any other mathematical relationship that represents quantity of tags incrementally along the y-axis may be employed.

As may be appreciated, different users may apply different tags to the same video, including slightly different tags (e.g. “cool” versus “neat”) and radically different tags (e.g. “awesome” versus “horrifying”). The system may process tag results for display in any meaningful way, including displaying the greatest number of tags, or alternately scoring a tag on a scale (e.g. “awesome” being a 10 score, “horrifying” being a zero score) and displaying a composite average, mean value, or other quantity based on the number of such tags received, or in some instances, simply considering tags as “positive” or “negative” or “neutral” and displaying the relative relationship of positive, negative, and neutral tags applied in the resultant histogram. Again, numbers of tags may be represented by the system in that a small number of tags may result in a small histogram bar while a large number results in a large histogram bar, or the result may be centered with “positive” values accorded to positive tags, and “negative” values to negative tags, and a cumulative score visually represented above or below a “zero” line, representing neutral. In short, any reasonable, available, and acceptable representation may be provided.

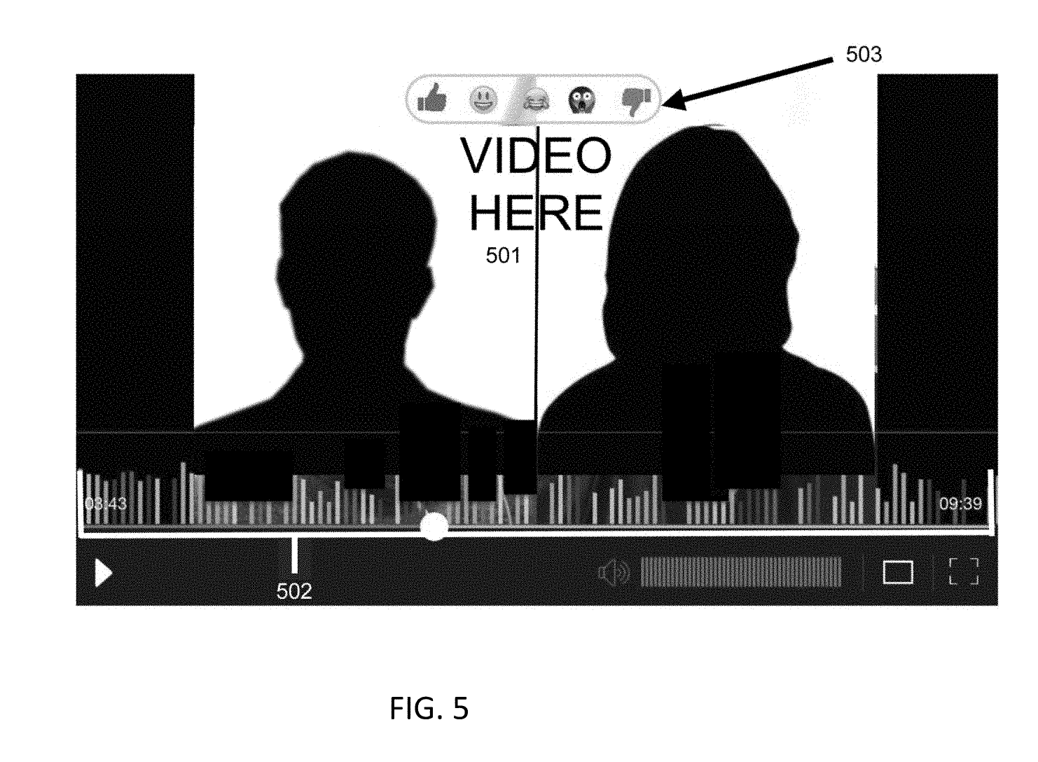

Colors may also be provided with the histogram, with brighter colors representing more emphasized values and lighter colors less emphasized values. For example, bright red may represent a relatively or absolute large number of “bad” or “critical” tags, while light green may represent a relatively or absolute small number of “good” tags, and white may represent neutral tags. In one instance, the system may denote an emoji or other tag most represented in a partition using a color, shape, or text label. One example of such a histogram is shown in FIG. 5, showing video 501 and histogram 502. Also indicated in FIG. 5 are selectable icons 503 representing elected reactions or opinions of video being viewed, where in this instance the colors correspond to the most used tag in the partition. The user can, if she desires, move to the part of the video having a histogram value or values of interest and simply watch that desired portion.

Analysis 402 thus represents analyzing the tags, such as the number and nature of the tags as represented above, and representation 403 comprises visually representing the tags in a meaningful way in association with the media or information presented such that the user can perceive the information and employ the information as desired.

Interaction 404 calls for the system to consolidate the bars representing the partitions above or below the video or representation in question, for example a representation where the cursor or indicator on the x-axis corresponds to video frames within the partition represented as a histogram bar at that position. In this arrangement, the user can view information or video evoking the strongest reactions in other users. Further, the system may provide so-called “snapping” functionality using a video tagging/playback tool, described in further detail herein, wherein the system allows the user to move to a desired portion of the audio or video based on determinations made, such as the variations in relative number of emoticons or tags provided between partitions. Put another way, the optional snapping functionality enables the user to manually jump to the spikes in number of tags, or the system may employ a snapping tool to help the user skip to the spikes.

In the case of dating, as noted, several swipe-dating mobile device applications exist. Such dating apps are characterized by users being invited to login via social media, upload personal data such as age, profession, education history, personal views, and opinions and to create a profile by uploading a main photo, secondary photos, a ‘tagline’ and a brief text biography that introduces the dater to other users.

During set-up (or afterward within ‘Settings’) users are typically invited to define preferences in a potential date according to age, location proximity and sex, such that short-form profiles of other daters fulfilling those preferences can be filtered and presented in turn, as part of a ‘profile stack’. The short-form profiles typically presented in the stack are limited to, for example, a main photograph, first name and age, whereby users can access the long-form profile by tapping the main photo. Tapping the main photo can provide access to the secondary photos and a short text bio.

Users swipe left (or select a ‘no’ button) for profiles they wish to dismiss, or swipe right (or select a ‘yes’ button) for profiles of interest. In the event that two users “swipe right” on each other, they are mutually issued a match notification and connected via a text messaging interface within the app.

The present design is, in one embodiment, a swipe-dating mobile app that features most or all of the traditional functionality described above, except that first names below profiles are represented instead by character strings chosen by each user as a USERNAME. Also offered is additional functionality referred to as ‘transparent dating’.

Transparent dating is broadly defined as functionality within a dating app environment whereby text, audio call, and video call interactions are possible between users via embedded communication software and recorded on a central server, which is then made available for playback to all other users via a dedicated user interface within the long-form profile called an interaction history.

Additionally, users agree to schedule dates via a system calendar function. In the case of top-rated daters the user can make table reservations within the app at pre-determined venues having recording devices that may be owned but are controlled at in least in part by the system. Such recording can record the dates. All daters are encouraged to record and upload before, during, and after the dates, and occasionally conduct interviews with hosts. This date media may also be uploaded to the individual's interaction history and playable by any user.

In general, the present design contemplates three classes of user. The first class is referred to as a “browser” and is a user who has not set up a profile but is able to access browse functionality to filter and browse other users, and play the media associated with the interaction histories of individuals or couples either selectively or chronologically.

The second class is a “swiper” who has created a profile and has the right to interact with other daters. Creating a profile may require a subscription. Such users are presented with profile stacks according to their preferences, and swipe and match according to the method described above.

The third class is a top rated dater, where this class includes a small number of top rated “swipers” as defined by their ratings from other users. While all daters may upload video or audio, top rated daters may be invited via notification and may schedule dates at predetermined locations and may be required to upload self-shot footage before and after dates, schedule dates in pre-determined date locations where the hosts have cameras available via a system calendar (available to all “swipers”), and may further be required to agree to specific terms and conditions.

In operation, the system may provide a header bar menu that features a ‘browse’ icon which takes any user to a browse page. The header may include functions such as Settings, Swipe, Chat, and the aforementioned Browse.

Typically, all users, subscribed or otherwise, may browse profiles. The system includes a filter menu that creates a shortlist of potential matches, identifying profiles according to arbitrary preferences such as location, rating, sex and age, which are then presented as a list of thumbnails. Top rated daters may be identified with a small star in the corner of his/her profile picture.

Selecting any profile thumbnail causes the system to display a long-form profile of that dater, which may include a link to his or her individual interaction history. An individual interaction history is represented as a scrollable, chronological series of interaction event bars, most recent at the top, divided by menu bars denoting the number of days since his or her profile was registered or date of registration, for example. In one optional embodiment, beneath the individual interaction history, a user may select ‘PLAY (Username's) STORY’ to chronologically play all media associated with the entire interaction history of that user, whereby the system plays the text/audio/video media associated with each interaction event or selected interaction events in, for example, a series of pop-up windows.

Also beneath or otherwise displayed with the individual interaction history, the system offers browsing users the option to rate the individual profile by selecting a rating button and applying a “star” rating, such as from one to five stars, or any other rating arrangement (1 to 10, 1 to 100, A through F, etc.) or to rate the individual profile by tagging the profile as a “favorite,” or in any other manner The system uses this information to determine which “swipers” are invited to become top rated daters.

The system also offers an interaction event bar, which is a representation of any ‘dating event’ that takes place for a given user, whether a text message, an audio call, a video call, or an actual date. Each event type has a corresponding icon (‘chat bubbles’, ‘telephone’, ‘video camera’, ‘wine glasses’) which is represented in the center of the interaction event bar. The system also visually represents the time of day of the event, the ‘to-from’ direction of the interaction (where applicable), as well the usernames of the two “swipers” involved in the event along with their thumbnail profiles.

Selecting any icon within an interaction event bar may generate a pop-up window, the content associated with which the system then plays to the browsing user, including the audio/video media associated with that date event. While the system is displaying any media, live selection by the viewer of an on-screen positive or negative emoticon tags the media at the corresponding frame with user feedback about the quality of the content as discussed more fully above. The metadata associated with these tags can later be used to identify the most usable content for promotional materials such as highlights for social media or TV content.

Typically, a popular dater will receive many messages that go unanswered. For the simplicity of an individual dating history, the system may represent these events as an entire interaction event bar. The system may consolidate all unanswered messages on a given day into a single, expandable interaction event bar.

The system may also offer an ability for a user to select couple history within an interaction event bar and may offer the ability to create a couple interaction history. A couple interaction history is typically identical to the individual interaction history, but filtered by the system to feature chronological interactions between the two daters in question. In one embodiment, the other side of the interaction event bar includes a sharing button, which allows users to post content (of themselves or others) to social media.

Users, and in particular “swipers” and top rated daters, who “match” with another entity can text message the other entity at any time using the present design, but once matched they can audio call or video call those other entities as well. In one instance matches can be purchased or otherwise acquired, giving an ability for the “swiper” or top rated dater to communicate in the foregoing ways. This is made possible by established connectivity software embedded in the system. The system may generate an interaction event bar corresponding to the event. The system then adds the event chronologically to both users' the individual interaction histories such that the media associated can be played by other users.

If two users arrange a date, the system allows them to register that date via a calendar within the app and provide a review, such as a video review before, during, and after the date as desired. In one optional embodiment, once the other party to the date has confirmed the date took place an interaction event bar denoting a ‘date’ is generated for both participants in the normal way, where the reviews can be viewed by other users. In another embodiment, confirmations may not be required, where both entities mutually schedule the date and reviews are posted subsequently.

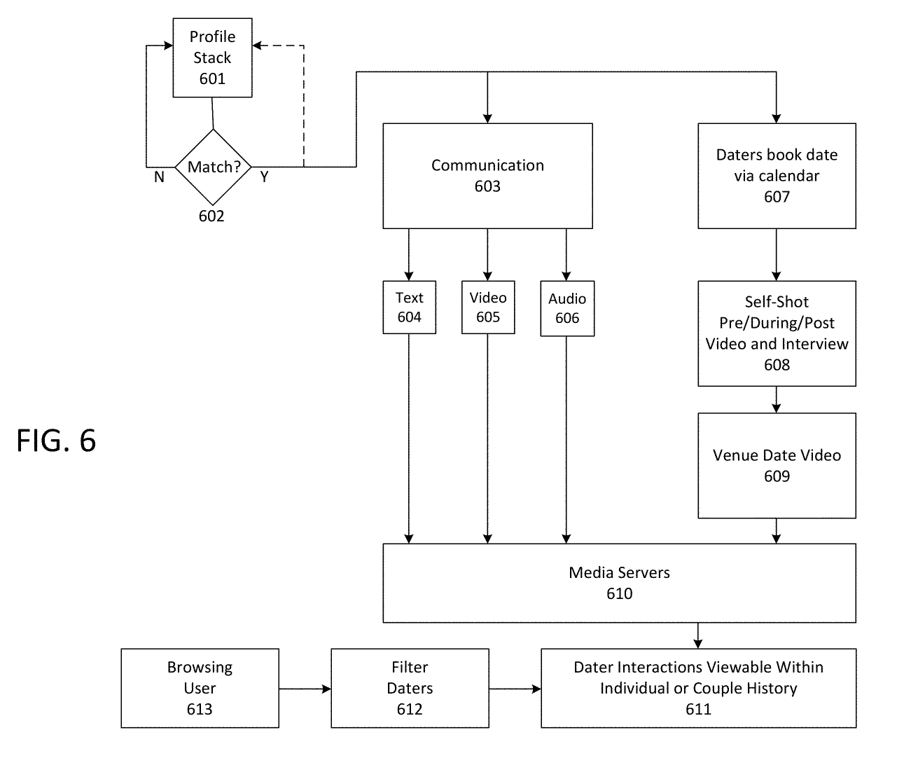

FIG. 6 illustrates an alternate representation of the present design, specifically relating to dating functionality. A profile stack 601 is maintained on the system, and at point 602 a user may sequentially swipe one or more profiles in the stack while the system determines swiping user and the user represented by the swiped profile have both swiped right. If yes, the system may offer the user in certain instances an ability to communicate at point 603, including text message 604, video call 605, or audio call 606. Alternately, the system may offer daters an ability to book a date via a calendar at point 607, may offer self-shot pre/during/post video at point 608, and camera date footage and/or interview functionality regarding the date may be provided at point 609. The information from the paths including points 603 to 609, may be provided to servers at point 610. At point 611, dater interactions are made viewable within the system within individual or couple date history. Point 612 represents a filtering of daters while point 613 represents a browsing user.

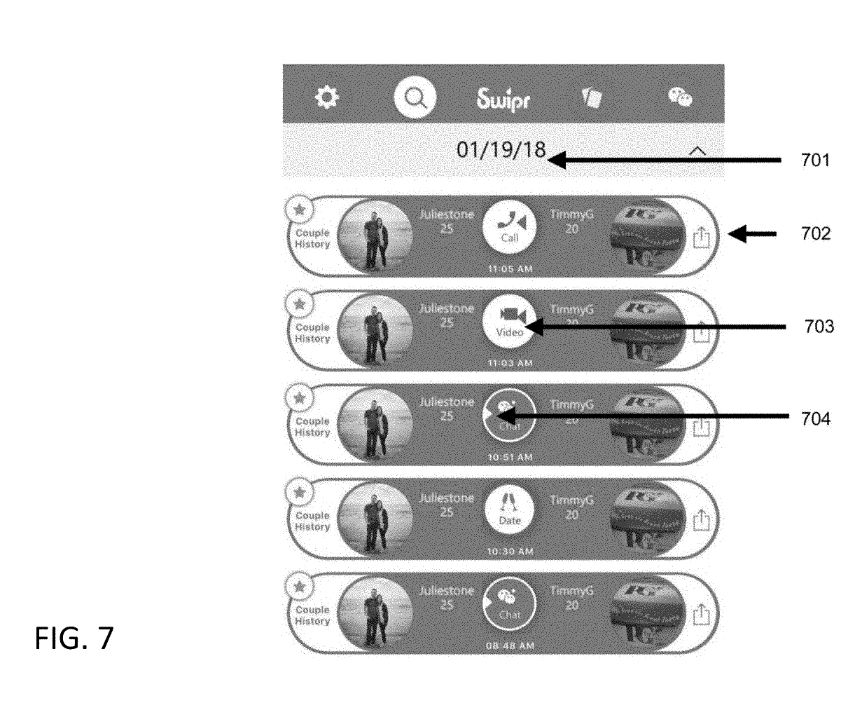

FIG. 7 conceptually shows individual interaction history. At point 701, the individual interaction history is presented chronologically, with the most recent interaction event uppermost, divided by header bars to denote days since the “swiper” created his or her profile. While FIG. 7 shows a number of days since daters matched, another option is to offer the current date. Point 702 illustrates the interaction event bar, representing any interaction between given “swipers.” At point 703, the icon within each interaction event bar denotes the type of event, such as a text message (in a “chat bubble”), audio call (represented by a telephone), video call (video camera) or date (“wine glasses”). At point 704, the “to-from” arrow represents the direction of the interaction between two “swipers.” Alternately, in an optional embodiment, browsing users can select a button to play all media associated with the individual interaction history sequentially. Browsing users can make a selection to rate an individual interaction history, such as from 1 to 5 stars, or 1 to 10 or 100, or using some other indication.

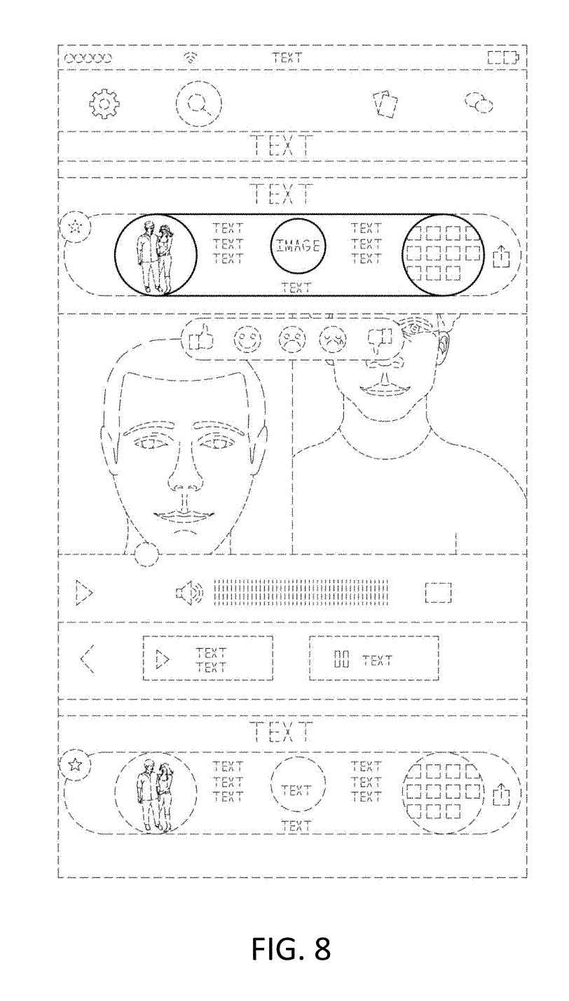

FIG. 8 illustrates one representation presented to a user.

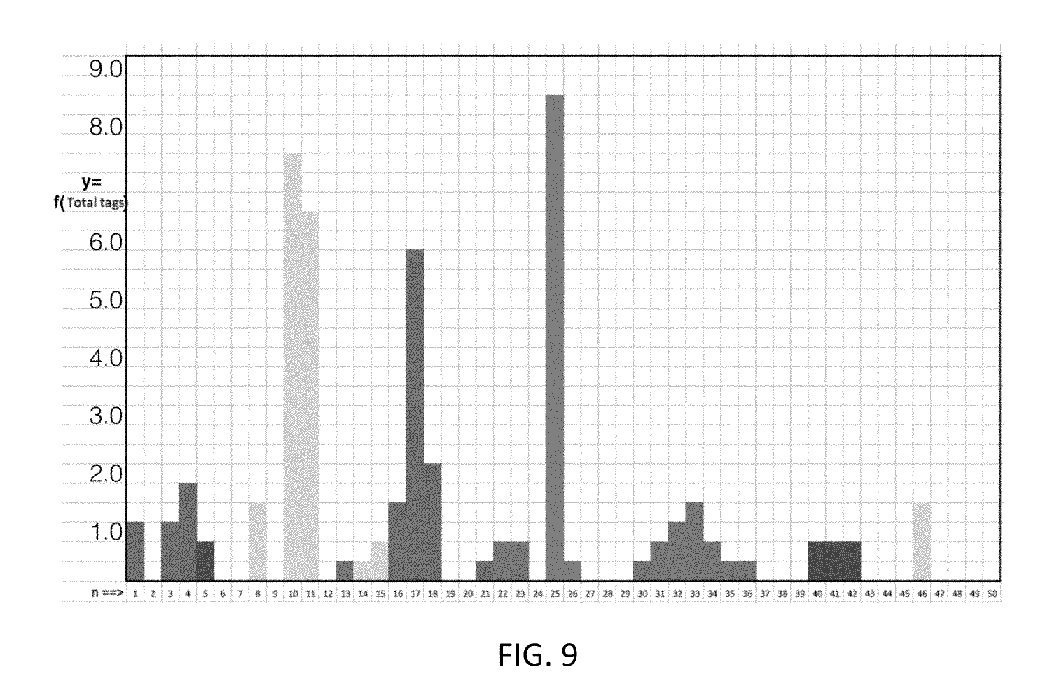

FIG. 9 illustrates an example of a histogram according to the present design. A histogram such as that shown in FIG. 9 may be superimposed over or beneath, for example, a video representation of a design. The user may be provided with a tool, called a snap or snapping tool. When the user activates the tool, the user can optimize viewing of the perceived “best” content in the video, enabling the user to “snap” to the points in the timeline immediately preceding the most tagged or most desired video based on prior ratings or tags applied.

FIG. 9 corresponds to a video of duration 500 seconds, with n equal to 50 partitions, each partition containing 10 seconds, or 250 frames, of video. These partitions are represented along the x axis, while the amplitude of the bars on the y axis represent the value of a function of total tags that, in the case of FIG. 9, are an incremental logarithmic value representing the total number of tags in a partition, tending to a maximum of 10.

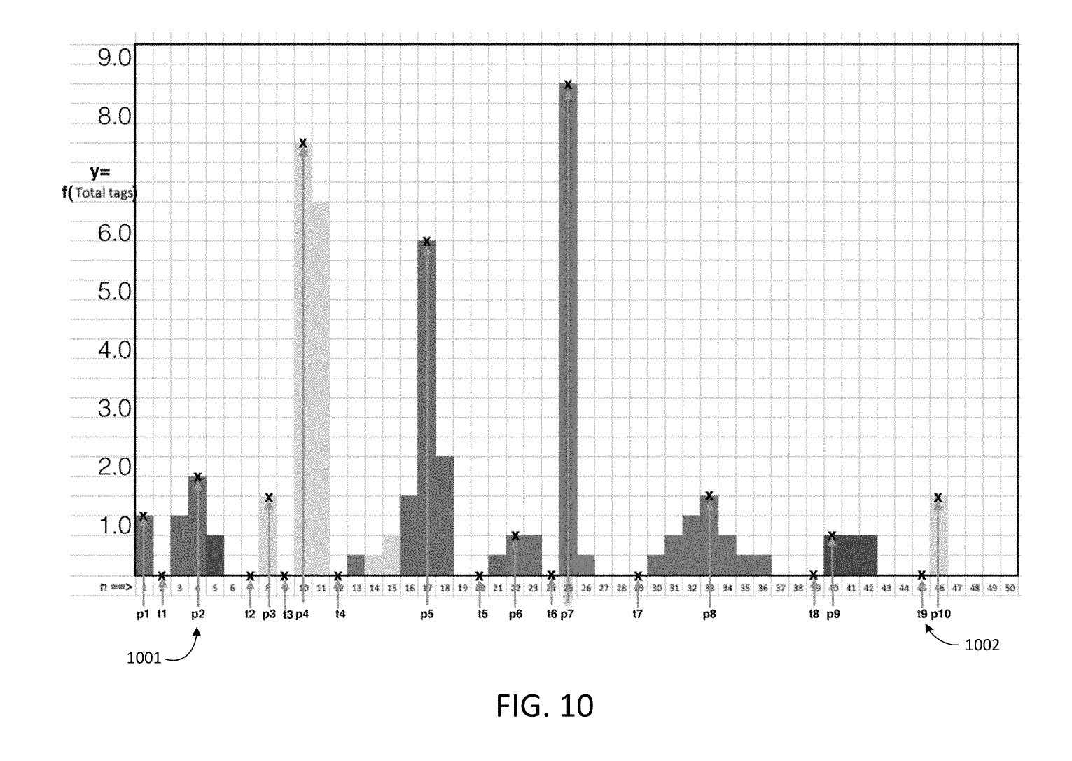

FIG. 10 illustrates one aspect of the functional operation of the present design as it relates to the snap tool. From FIG. 10, the system initially identifies a series of key points within the histogram. Two types of key points may be identified—peak point and trough point. A peak point is identified in FIG. 10 via the letter “p” such as peak point p2 at point 1001. A trough point is identified in FIG. 10 via the letter “t” such as trough point t9 at point 1002. The system identifies a point as a peak point if y(n) is greater than y(n−1) and y(n) is greater than the next y value that is not equal to y(n). The system identifies a point as a trough point if y(n) is less than y(n+1) and y(n) is less than the previous y value that is not equal to y(n). The system may assess initial conditions; for example, the system evaluates y(1) based solely on y(2), as no y(0) is provided.

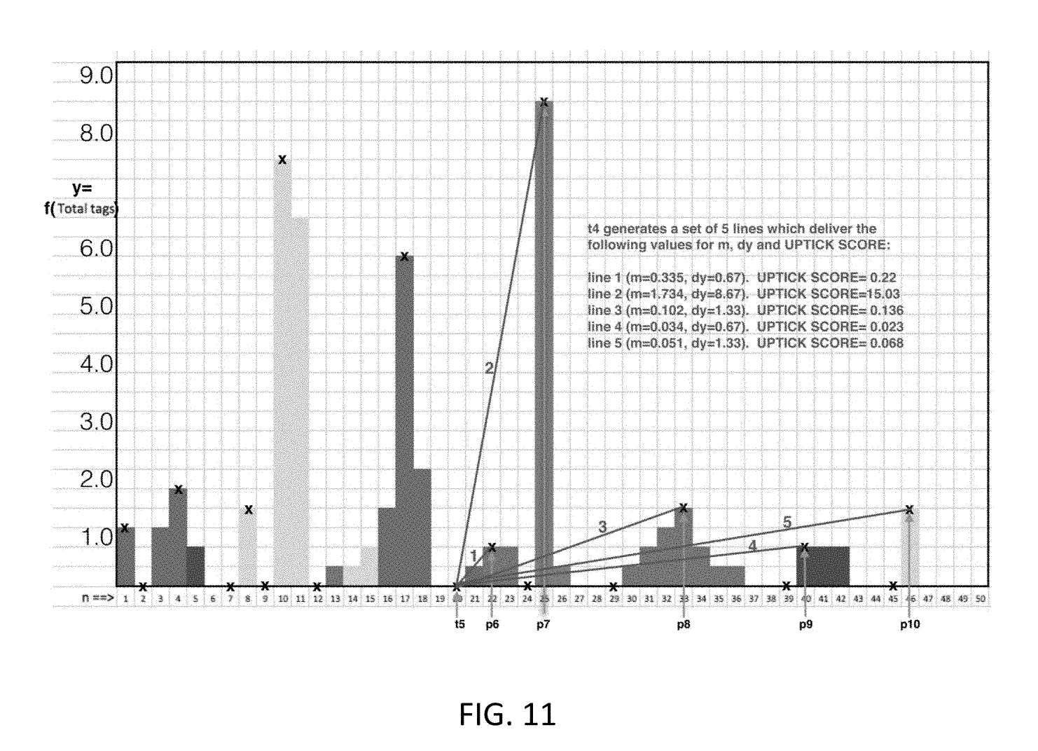

FIG. 11 illustrates the system iteratively generating a series of lines from a trough point to subsequent peak points with a higher partition value. In FIG. 11, the system generates five lines originating from trough point t5 (t5 to p6, p7, p8, p9, and p10). While five lines are shown, the system generates lines for all trough points to all relevant subsequent peak points. The system operates until lines have been generated for all troughs, from the representations shown a total of 45 lines (9+8+7 . . . +3+2+1). For each line, the system calculates a value for the line gradient and the difference in y value from trough point to the respective peak point. The system calculates an uptick score representing a function of the gradient (m) and the difference in y value (denoted dy herein), in general representing a difference between very few tags or other markers and a very large number of tags or markings. Uptick scores may be used to direct users to particular portions or partitions of the representation. One uptick value calculation is m multiplied by dy. Thus in the case of the lines shown in FIG. 11, the largest uptick score originating at trough point t5 is generated by line 2 having a calculated value in this example of 15.03. This represents a significant number of tags or markers and would direct the user, in one embodiment, to partitions 20 through 25 in the FIG. 11 representation.

With respect to uptick scores, uptick score determination, and uptick processing in general, allows the user to more quickly access or prioritize the information contained in those partitions that follow the start points or partitions of the most significant upticks, whether these partitions are represented visually for manual access, or in concert with a “snap tool” that allows the user to jump between the partitions. In other words, uptick processing identifies the most significant spikes in tag volume (based on gradient and size of the spike) on the assumption that the biggest spikes correspond to the ‘key moments’ in the video. Once identified, the partitions at which these spikes begin can operate in conjunction with a snapping tool such that the viewer scrubs or moves along the timeline and jumps to a “key moment.”

The system may generate an uptick score that is a function of some or all of three quantities—the amplitude of the uptick (dy), the gradient of the uptick (m) and the tag volume represented by the peak, calculated in one instance as a sum of all values for y at each subsequent value for n, until a moving average value for y drops below a threshold. In some embodiments, two of the three values may be employed to determine uptick. Other measurements and calculations may be employed as desired, including the user(s) being part of selected groups, use of weightings, etc.

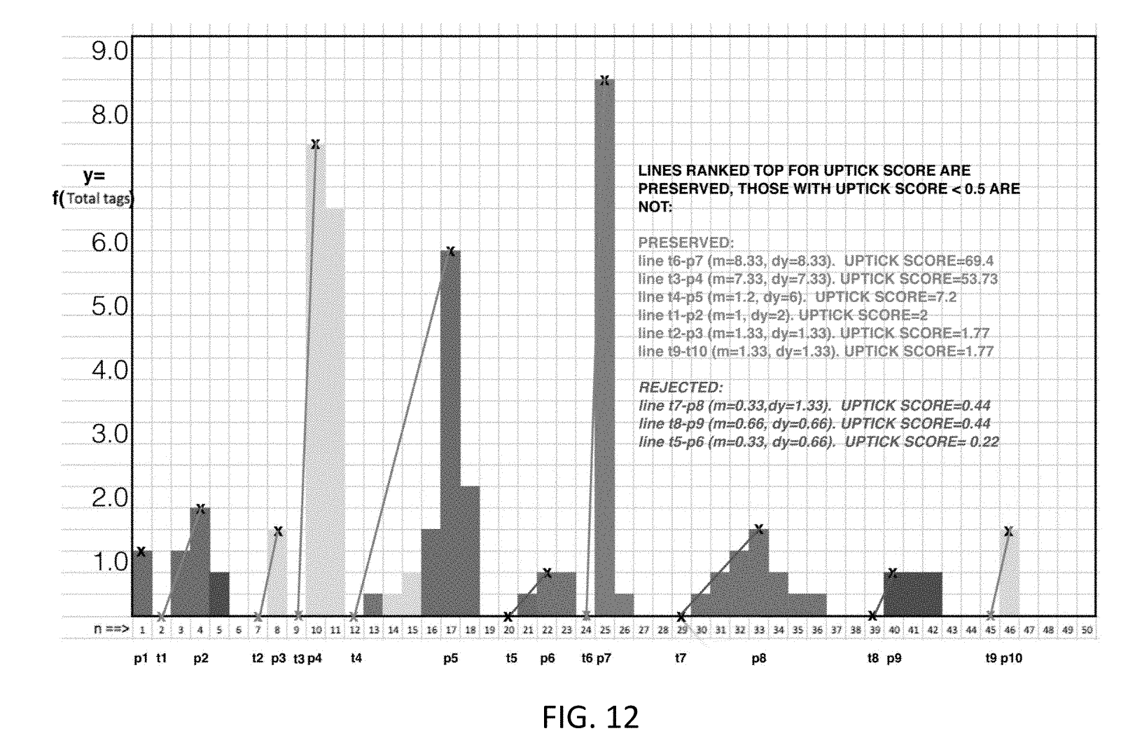

FIG. 12 shows one embodiment of a system ranking for uptick scores. The system ranks all 45 lines for uptick scores and determines lines having an uptick score greater than a certain value, such as 0.5. Alternately, the system may keep a certain number of lines or a top scoring percentile of lines. In one instance, if more than one line is selected and ends at the same peak point, the system may select the line with the highest uptick score, representing partitions of particular interest or noteworthiness. The system identifies as “snap points” the trough points representing the point of origin of all preserved lines. In FIG. 12, t5, t7, and t8 are not snap points as those lines do not satisfy the threshold established. The system may direct users to partitions with high uptick scores and away from partitions with low or discarded uptick scores.

Thus according to one embodiment, there is provided a system for enhancing user selection of information. The system includes an information providing element configured to provide information related to a first entity to a user, a partitioning element configured to partition the information into a set of partitioned items, means for the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied in the graphical format representation. The system thus includes a video tagging/playback tool useful in creating an enhanced entertainment experience.

According to a further embodiment, there is provided a system for enhancing user selection of information, comprising an information providing element configured to provide information related to a first entity to a user, a partitioning element configured to partition the information into a set of partitioned items, a tag applicator enabling the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied using the tag applicator in the graphical format representation.

According to another embodiment, there is provided a system for enhancing user selection of information, comprising an information providing element configured to provide information related to a first entity to a user, a partitioning element configured to partition the information into a set of partitioned items, a tag applicator enabling the user to apply at least one tag to each item in the set of partitioned items, a representation element configured to represent all tags applied to the set of partitioned items to the user in a graphical format representation, and an interaction element configured to enable the user to select a desired partitioned item for review based on all tags applied using the tag applicator in the graphical format representation. The interaction element is configured to determine an uptick score representing a difference in applied tags and/or markings at a low trough partition and applied tags and/or markings at a high peak partition.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another, i.e. may include transitory and/or non-transitory computer readable media. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A system for enhancing user selection of information, comprising:
an information providing element configured to provide information related to a first entity to a user;
a partitioning element configured to partition the information into a set of partitioned items;
means for the user to apply at least one tag to each item in the set of partitioned items;
a representation element configured to represent all tags applied to the set of partitioned items to the user in a graphical format representation; and
an interaction element configured to enable the user to select a desired partitioned item for review based on all tags applied in the graphical format representation.

2. The system of claim 1, wherein the information comprises video information.

3. The system of claim 1, wherein the tag comprises one of an emoji, text information, and a color representation.

4. The system of claim 1, wherein the first entity comprises a person and the system is employable by the user to determine information about the first entity for purposes of potentially physically encountering the first entity.

5. The system of claim 1, wherein the information comprises text information exchanged between the first entity and a second entity.

6. The system of claim 3, wherein the color representation comprises bright colors representing emphasized values and lighter colors less emphasized values or a most used tag in the partitioned item.

7. The system of claim 1, wherein the interaction element computes an uptick score representing a difference in applied tags and/or markings from a low trough partition to a high peak partition.

8. A system for enhancing user selection of information, comprising:
an information providing element configured to provide information related to a first entity to a user;
a partitioning element configured to partition the information into a set of partitioned items;
a tag applicator enabling the user to apply at least one tag to each item in the set of partitioned items;
a representation element configured to represent all tags applied to the set of partitioned items to the user in a graphical format representation; and
an interaction element configured to enable the user to select a desired partitioned item for review based on all tags applied using the tag applicator in the graphical format representation.

9. The system of claim 8, wherein the information comprises video information.

10. The system of claim 8, wherein the tag comprises one of an emoji, text information, and a color representation.

11. The system of claim 8, wherein the first entity comprises a person and the system is employable by the user to determine information about the first entity for purposes of potentially physically encountering the first entity.

12. The system of claim 8, wherein the information comprises text information exchanged between the first entity and a second entity.

13. The system of claim 10, wherein the color representation comprises bright colors representing emphasized values and lighter colors less emphasized values or a most used tag in the partitioned item.

14. The system of claim 8, wherein the interaction element computes an uptick score representing a difference in applied tags and/or markings from a low trough partition to a high peak partition.

15. A system for enhancing user selection of information, comprising:
an information providing element configured to provide information related to a first entity to a user;
a partitioning element configured to partition the information into a set of partitioned items;
a tag applicator enabling the user to apply at least one tag to each item in the set of partitioned items;
a representation element configured to represent all tags applied to the set of partitioned items to the user in a graphical format representation; and
an interaction element configured to enable the user to select a desired partitioned item for review based on all tags applied using the tag applicator in the graphical format representation;
wherein the interaction element is configured to determine an uptick score representing a difference in applied tags and/or markings at a low trough partition and applied tags and/or markings at a high peak partition.

16. The system of claim 15, wherein the information comprises video information.

17. The system of claim 15, wherein the tag comprises one of an emoji, text information, and a color representation.

18. The system of claim 15, wherein the first entity comprises a person and the system is employable by the user to determine information about the first entity for purposes of potentially physically meeting the first entity.

19. The system of claim 15, wherein the information comprises text information exchanged between the first entity and a second entity.

20. The system of claim 17, wherein the color representation comprises bright colors representing emphasized values and lighter colors less emphasized values or a most used tag in the partitioned item.
